(19) United States
(12) Patent Application Publication
(10) Pub. No.: US 2004/0236678 A1
(43) Pub. Date: Nov. 25, 2004

(54) Better register

(76) Inventors: Beverly Jane Johns, Edgewood, NM (US); Richard Harold Krukar, Albuquerque, NM (US)

Correspondence Address: RICHARD KRUKAR, 4717 BALI CT NE, ALBUQUERQUE, NM, 87111, US

(21) Appl. No.: 10/845,376

(22) Filed: May 13, 2004

Related U.S. Application Data
(60) Provisional application No. 60/473,227, filed on May 24, 2003.

(51) Int. Cl. G06F 17/60

(52) U.S. Cl. 705/38

(57) ABSTRACT

A financial data tracking tool incorporating 10 tools is presented. The 10 tools include 4 ledgers, a budget tracker, an account information tracker, a balance tracker, an automatic payment reminder, a bill tracker, and a life energy tracker. An important feature of the invention is that it is easy to carry while still incorporating all 10 tools. The specific embodiment of the invention can be a printed booklet or computer software running on hardware such as a cell phone.

### CROSS-REFERENCE TO RELATED APPLICATIONS

The present invention was previously disclosed as provisional patent 60/473.227 titled “Better register for easily tracking cash flow and net worth”.

### STATEMENT OF GOVERNMENT INTEREST

No government funding, from any government, has gone into the development of the present invention. There is no government interest in this invention.

### FIELD OF THE INVENTION

The present invention relates to the field of financial data tracking tools. Financial data tracking tools are typically used to track the flow of money to and from an organization or individual. More specifically, the present invention is a financial data tracking tool that is both handy and able to track information, such as the life energy costs of transactions, that is not normally tracked in a single useful tool.

### BACKGROUND OF THE INVENTION

Financial data tracking tools (FDTTs) are common items with a history extending back to the invention of writing. Originally, even the ability to track the information was new. Enormous amounts of financial data are now tracked and a whole industry, the accounting industry, exists to perform the function. However, even with all of today's advanced techniques and computerization almost no individual person is capable of generating a marginally accurate picture if their own wealth and cash flows. Additionally, corporations, accountants, and wealthy individuals are comfortable in tracking everything, including labor, as a monetary expense. For a layperson, labor is more than an expense; it is the sweat of their own brow and the minutes of their life flowing away and never to return.

Most people desiring to track their finances create budgets. A budget is a formalism in which areas of someone's life are categorized and assigned an allowable periodic financial expenditure. Budgets are good tools for creating plans, but are notoriously unreliable in leading people away from financial problems. The reason is that budgets are not good at telling people how hard they worked for each line item in their budget.

There are many systems, some patented, for tracking financial data. There are computerized systems for individuals, such as the Quicken product from Intuit. There are paper based products such as described in U.S. Pat. No. 5,882,041. These are all excellent systems for what they are intended. However, they are not sufficient for helping a person who is financially unsophisticated to develop an understandable picture of their own finances and express that picture in terms that matter. What matters is where the money is going by identifying the little items upon which cash is squandered. What matters is understanding how hard and how long it was to get the cash that was squandered.

The Better Register (TBR) is a tool for the layperson to use for creating and keeping an accurate and comprehensible picture of their finances. It is a tool with which someone can gather together all his or her financial data into a small convenient package, carry it, maintain it, and have on hand an understandable picture of their own finances. For many people, The Better Register is the only way they will ever be able to control their finances and tame they buying impulse.

### BRIEF SUMMARY OF THE INVENTION

The Better Register is a set of ten tools combined into a single convenient and handy package.

The first tool is an information tracker for recording loan or credit account data including lending institution, purchase interest rate, cash interest rate, days in billing cycle, customer service number, and a reference to the account number.

The second tool is a balance tracker wherein periodic balances are recorded for the accounts recorded in the information tracker.

The third tool is a bill tracker wherein the due dates for bills are recorded.

The fourth tool is an automatic transaction reminder wherein the transaction dates for automatic financial transactions are recorded.

The fifth tool is for checking accounts. The fifth tool has at least one checking account ledger wherein financial transactions involving a checking account are recorded.

The sixth tool is a cash account ledger wherein financial transactions involving actual currency on hand are recorded.

The seventh tool is for savings accounts. The seventh tool has at least one savings account ledger wherein financial transactions involving a savings account are recorded.

The eighth tool is for credit cards. The eighth tool has at least one credit cards and loans account ledger wherein financial transactions involving credit cards and loans are recorded.

The ninth tool is a budget tracker wherein the transactions recorded in the ledgers are assigned to a budget category.

The tenth tool is a life energy tracker wherein the transactions recorded in a ledger, which are recorded in terms of money, are also recorded and tracked in terms of life energy spent.

A distinguishing aspect of the invention is that all ten tools are present. One way to use the invention is to create a form or table for use with each tool, print the forms or tables, and bind them together to form a convenient package. Another way to use the tool is as a graphical user interface used in conjunction with a computer database.

### BRIEF DESCRIPTION OF THE DRAWINGS

FIG. 1 shows an information tracking tool presented as a table on a printed form.

FIG. 2 shows pages 10-11 of The Better Register user manual.

FIG. 3 shows a balance tracking tool presented as a table on a printed form.

FIG. 4 shows pages 12-13 of The Better Register user manual.

FIG. 5 shows a bill tracker presented as a calendar on a printed form.

FIG. 6 shows pages 14-15 of The Better Register user manual.

FIG. 7 shows an automatic transaction reminder presented as a table on a printed form.

FIG. 8 shows pages 16-17 of The Better Register user manual.

FIG. 9 shows a transaction ledger presented as a table on a printed form. The transaction ledger contains a check ledger, cash ledger, savings ledger, credit card and loan account ledger, a budget tracker, and a life energy tracker.

FIG. 10 shows pages 18-19 of The Better Register user manual.

FIG. 11 shows pages 20-22 of The Better Register user manual.

### DETAILED DESCRIPTION OF THE INVENTION

The present invention is a set of ten tools combined into a single convenient and handy package. Every tool in the set can take the form of a table printed on a piece of paper. The Better Register product as currently produced is a grouping of tables printed on paper and folded longitudinally. The present invention is not limited to the physical form of the current Better Register product, but the figures included in this patent specification are all taken from that product.

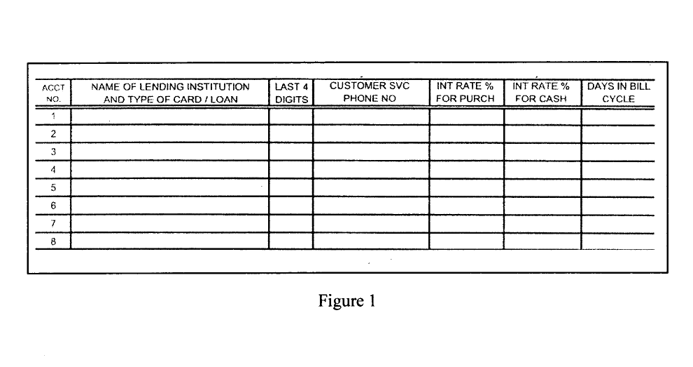

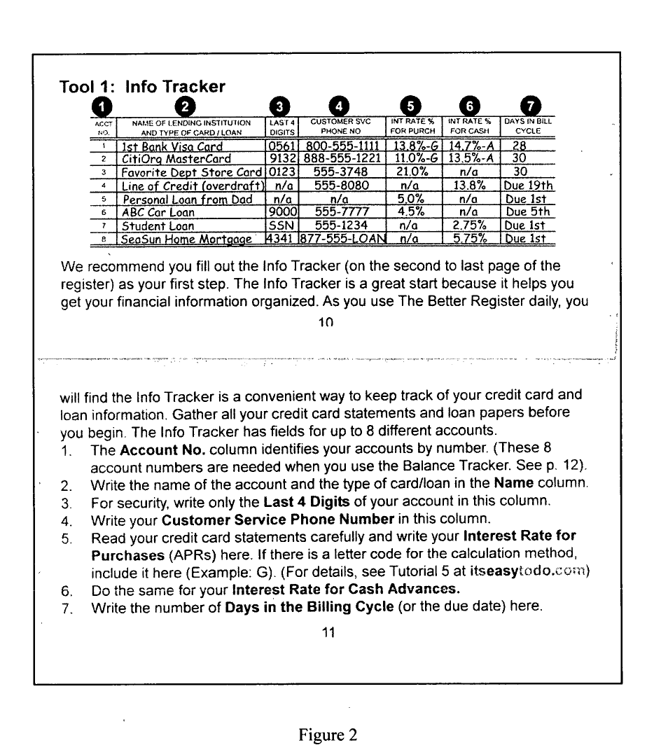

The first tool is an information tracker for recording loan or credit account data. Information that can be recorded for each account in the information tracker includes lending institution, purchase interest rate, cash interest rate, days in billing cycle, customer service number, and a reference to the account number. FIG. 1 shows the information tracking table in the current Better Register product. In FIG. 1, each row can contain the information for one account. Therefore, the first row in the table can contain information for account 1 while row 2 can contain the information for account 2. The table in FIG. 1 has 8 rows and can therefore contain information for 8 accounts. Other embodiments of the invention can allow recording of information for different numbers of accounts. FIG. 2 shows pages 10-11 of The Better Register users manual. Those pages contain the instructions for using the information tracker in that embodiment of the invention.

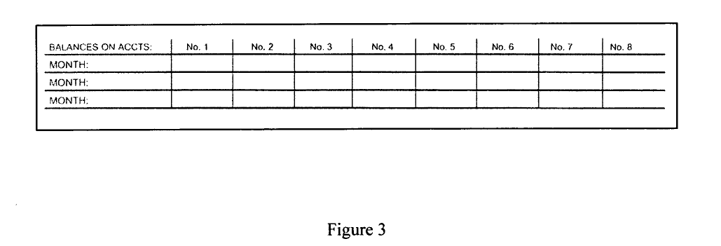

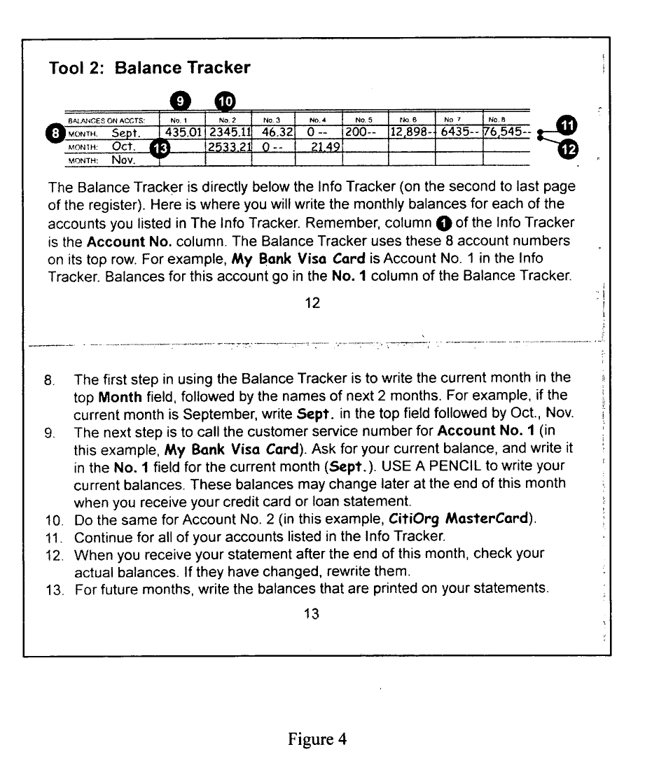

The second tool is a balance tracker wherein periodic balances are recorded for the associated accounts in the information tracker. FIG. 3 shows the balance tracking table in the current Better Register product. Each row in the table represents a single time period. In FIG. 3, the time period is one month. The columns in the table are labeled No. 1 through No. 8. Each column in the balance tracker corresponds to a row in the information tracker. Referring to FIG. 1 and FIG. 3, row 1 in the information tracker of would contain important information for account number 1. Column 1 in the balance tracker would contain the account balance at the end of each time period. An example of a time is “May 2004” in which case the balance recorded is the amount of money in the account on May 31, 2004. Other embodiments of the invention can allow for different numbers of accounts and a different number of time periods. FIG. 4 shows pages 12-13 of The Better Register users manual. Those pages contain the instructions for using the balance tracker in that embodiment of the invention.

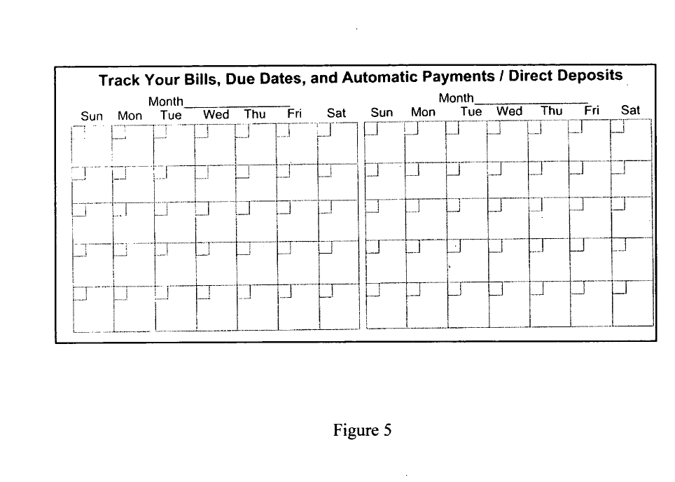

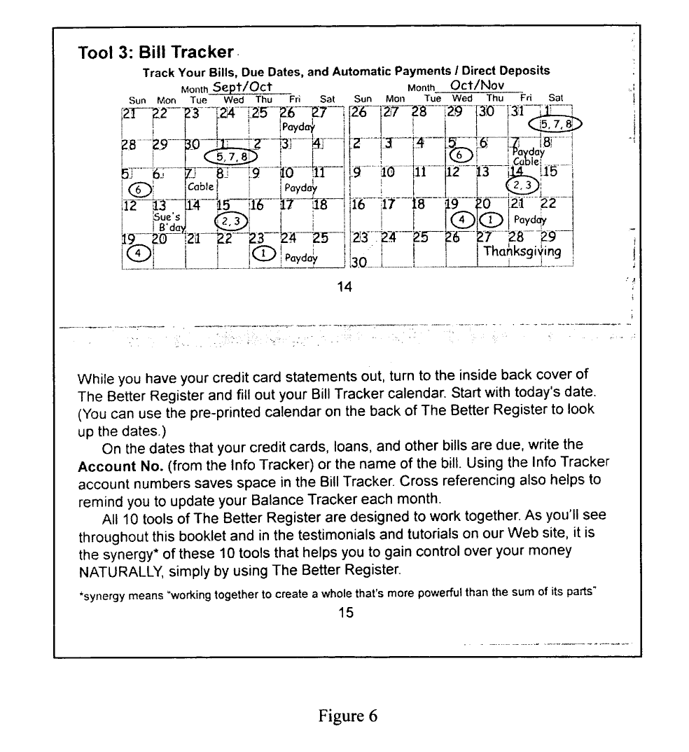

The third tool is a bill tracker wherein the due dates for bills are recorded. FIG. 5 shows the bill tracker in the current Better Register product. The Figure shows two identical tables. Each table contains 5 rows. Each row is divided into seven sections corresponding to a day of the week. Each section has a small square in the upper left corner where the day of the month can be written. The rest of the section is a space wherein the details of scheduled payments can be entered. FIG. 6 shows pages 14-15 of The Better Register users manual. Those pages contain the instructions for using the bill tracker in that embodiment of the invention.

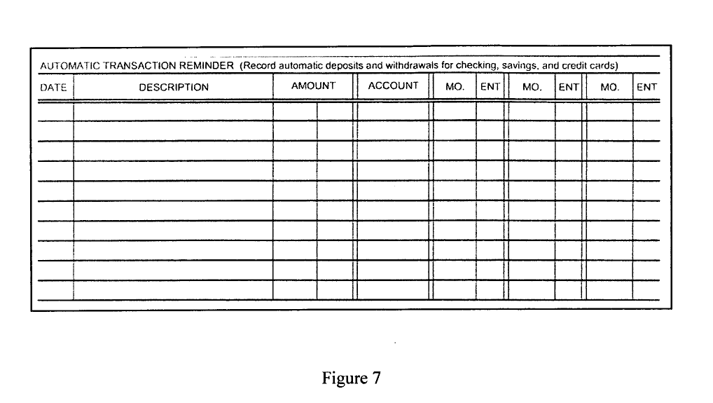

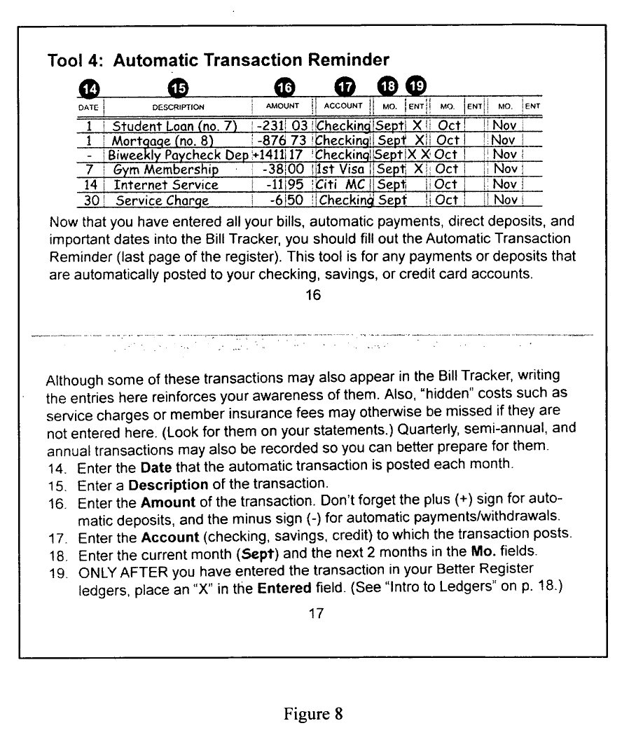

The fourth tool is an automatic transaction reminder wherein the transaction dates for automatic financial transactions are recorded. FIG. 7 shows the automatic transaction reminder in the current version of The Better Register. It contains information about automatic transactions and may duplicate information in the bill tracker. The information recorded for each automatic transaction comprises the day in the billing period, a description of the transaction, the transaction amount, the account to which the transaction posts, as well as some information for certain billing periods. The information for certain billing periods comprises the name of the billing period and a place to note if the transaction has been entered into a ledger. FIG. 8 shows pages 16-17 of The Better Register users manual. Those pages contain the instructions for using the automatic transaction reminder in that embodiment of the invention.

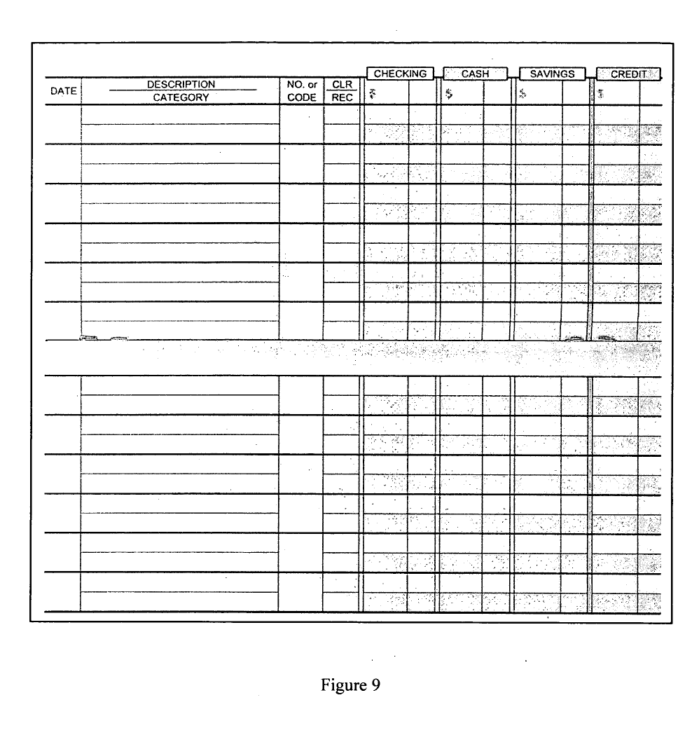

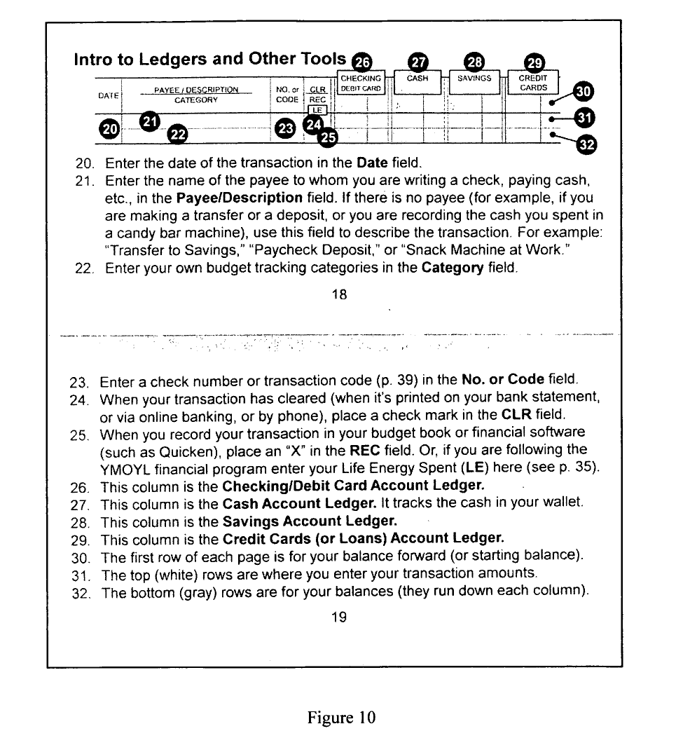

The remaining 6 tools are either ledgers or closely associated with ledgers. A ledger is used to track the balance, which is usually the amount of money, in an account or a group of accounts. A ledger entry comprises a transaction date, transaction description, transaction amount, and account balance. Ledgers usually have an initial entry for the initial balance. FIG. 9 shows a page from the current version of The Better Register's transaction register. The transaction register contains all 6 of the remaining tools. FIG. 10 shows pages 18-19 of The Better Register users manual. Those pages contain a very brief introduction to the 4 ledger tools, the budget tracker, and the life energy tracker.

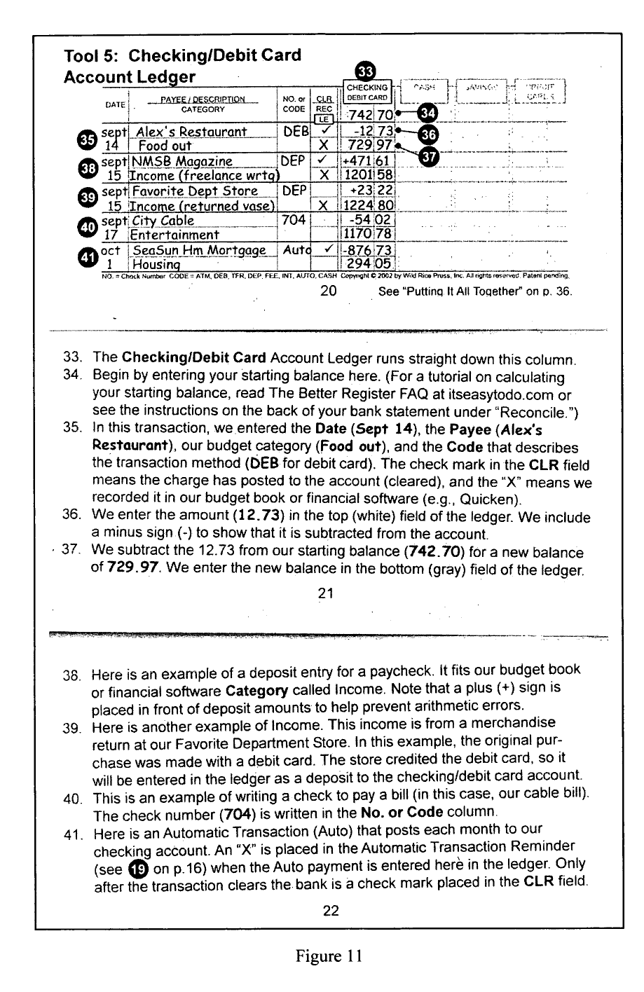

The fifth tool is for checking accounts. The fifth tool has at least one checking account ledger wherein financial transactions involving checking accounts are recorded. FIG. 9 shows the checking account ledger in the current version of The Better Register. In this particular embodiment, the checking account ledger is combined with 5 other tools. FIG. 11 shows pages 20-222 of The Better Register users manual. Those pages contain detailed instructions for using the checking account ledger.

The sixth tool is a cash account ledger wherein financial transactions involving actual currency on hand are recorded. The only difference between the cash account ledger and the checking account ledger is where the associated money is kept. Checking account ledgers refer to money kept in checking accounts at a financial institution. Cash ledgers refer to the actual currency that a person has access to. FIG. 9 shows a cash ledger incorporated with other ledgers.

The seventh tool is for savings accounts. The seventh tool has at least one savings account ledger wherein financial transactions involving a savings account are recorded. The only difference between the savings account ledger and the checking account ledger is where the associated money is kept. Checking account ledgers refer to money kept in checking accounts at a financial institution. Savings account ledgers refer to money kept in savings accounts at a financial institution. FIG. 9 shows a cash ledger incorporated with other ledgers.

The eighth tool is for credit cards. The eighth tool has at least one credit cards and loans account ledger wherein financial transactions involving credit cards and loans are recorded. The only difference between the credit cards and loans account ledger and the checking account ledger is where the associated money is kept. Checking account ledgers refer to money kept in checking accounts at a financial institution. Credit cards and loans ledgers refer to balances, usually negative, associated with lending from a financial institution. FIG. 9 shows a credit cards and loans ledger incorporated with other ledgers.

The ninth tool is a budget tracker wherein the transactions recorded in the ledgers are assigned to a budget category. FIG. 9 show a budget tracker in the column marked “No. or Code” incorporated with 4 ledgers and a life energy tracking tool. The users guide pages shown in FIG. 10 discuss the budget tracker and how to use it. FIG. 11, showing The Better Register's user's manual instructions for using the checking account ledger also discusses using the budget tracker.

The tenth tool is a life energy tracker wherein the transactions recorded in a ledger, which are recorded in terms of money, are also recorded and tracked in terms life energy. Life energy is a concept discussed in books such as “Your Money or Your Life” that helps people visualize the true cost of a transaction. The true cost of a transaction varies from person to person because it shows how long someone worked for the money that was spent. In the most simple form, life energy is the transaction amount divided by a person's true working wage. A person's true working wage is what that particular person earns per unit of time. For example, some may have a $4000/month wage. But it cost $1000 in meals, commuting etc. to keep that job. Also, in an average month, that person spends 11 hours/day away from home earning that money. So, that person averages 229 hours to earn $3000, or $13.10/hour. To make a single $100 purchase, that person spends about 7.6 hours of life. The life energy expenditure in this case is 7.6 hours. There are other ways to calculate life energy, but what is important is that it be calculated and tracked. FIG. 9 show a life energy tracker in the column marked “CLR/REC” incorporated with 4 ledgers and a budget tracking tool. The users manual pages shown in FIG. 10 discuss the life energy tracker and how to use it. FIG. 11, showing The Better Register's user's manual instructions for using the checking account ledger, also discusses using the life energy tracker as a posted/recorded marker.

A distinguishing aspect of the present invention is that all ten tools are present. One embodiment of the invention, The Better Register, has been discussed in detail in this specification. There are other possible embodiments of the invention. There are other ways to print the tables, bind them, and present the invention to the user. The tables embodying the invention could be translated into another language. Different printing, binding, or languages does not change the nature of the invention. The present is a combination of synergistic tools in a handy package. If all the tools are present, then the invention is present.

The present invention includes ledgers that are specified by names such as “checking account register.” A checking account is a familiar concept in modern society, but goes by different names. Some financial institutions use the term “share draft account” instead of checking account. The term “checking account” is intended to refer to all equivalent account types. A similar discussion applies to the term “savings account.” The term savings account is intended to refer to all equivalent account types.

Some people do not have savings or checking accounts. They use a different type of account type such, as a brokerage account with check writing privileges. What is important for benefiting from use of the present invention is that the account balance be tracked using a ledger. All of the ledgers are functionally the same, differing only in the type of financial instrument they are associated with. The full benefits of the present invention may be realized by tracking brokerage accounts in the savings ledger or any other ledger. Optionally, another ledger may be added for brokerage type accounts.

The present invention comprises 10 different, related, and synergistic tools. Every one of the tools has been presented as a printed table or part of a printed table. Anyone familiar with computer programming can easily translate each table into a data structure. A slightly more advanced programmer would translate the table for use with a database. There are many database programs such as Oracle, PostgreSQL, and MySQL, which are specifically tailored for storing, manipulating, recalling tabular information. Similarly, we live in a computerized society in which data structures and database information are often presented to users. Usually, the information is presented in a graphical user interface (GUI). Products such as Microsoft's Money or Intuit's Quicken are examples of computer software that incorporates GUIs and databases. In both products, a user may review, enter or manipulate information in the database via the GUI. The present invention can be embodied using the same common technology as anything else that combines GUIs and data. The difference is that the present invention has all 10 tools tied together, nothing else in the market does. Anyone familiar with the printed version of the present invention and also familiar with computer programming could easily produce an electronic version of the present invention.

Electronic versions of the present invention could incorporate any of a number of common techniques. Common techniques include:

1. Web based interface to a remote server, similar to electronic account access and bill payment to an account over the world wide web.

2. A program on a computer or cell phone.

3. A front end application or “skin” connected to a back end utility.

The distinguishing characteristic of an electronic embodiment of the present invention is the presence of all ten tools. The underlying technology such as databases, data structures, GUIs, network connectivity, and data storage, and data synchronization are in common use as a part of modern life.

What is claimed is:

1. A financial data tracking tool comprising:
an information tracker for recording loan or credit account information;
a balance tracker wherein periodic balances are recorded for the accounts referenced in the information tracker;
a bill tracker wherein the due dates for bills are recorded;
an automatic transaction reminder wherein the transaction dates for automatic financial transactions are recorded;
at least one checking account ledger wherein financial transactions involving a checking account are recorded;
a cash account ledger wherein financial transactions involving actual currency on hand are recorded;
at least one savings account ledger wherein financial transactions involving a savings account are recorded;
at least one credit cards and loans account ledger wherein financial transactions involving credit cards and loans are recorded;
a budget tracker wherein transactions recorded in a ledgers are also assigned to a budget category; and
a life energy tracker wherein the transactions recorded in a ledger, which are recorded in terms of money, are also recorded and tracked in terms life energy.

2. The financial data tracking tool of claim 1 wherein the ledgers, budget tracker, and life energy tracker are combined into a single tabular display.

3. The financial data tracking tool of claims 1 and 2 wherein the tool is instantiated by printing on at least one sheet of paper or similar printable material.

4. The financial data tracking tool of claim 3 wherein multiple sheets are printed and bound together to form a single unit.

5. The financial data tracking tool of claims 3 and 4 wherein no more than one checking account ledger, no more than one savings account ledger, and no more than one credit cards and loans ledger are instantiated.

6. The financial data tracking tool of claim 1 wherein some or all of the information is entered into, stored in, and retrieved from a computer database.

7. The financial data tracking tool of claim 6 wherein some or all of the information is shared between two or more devices.

8. The financial data tracking tool of claims 6 and 7 wherein some or all of the information is encrypted.

9. The financial data tracking tool of claims 6-8 wherein some or all of the information is entered and displayed using a graphical user interface.
